(19) United States
(12) Patent Application Publication
(10) Pub. No.: US 2017/0358222 A1
(43) Pub. Date: Dec. 14, 2017

(54) Navigation System for Unmanned Aerial Vehicle

(71) Applicant: DENSO International America, Inc., Southfield, MI (US)

(72) Inventor: Ronald SCHUBERT, Canton, MI (US)

(21) Appl. No.: 15/182,210

(22) Filed: Jun. 14, 2016

(51) Int. Cl. G08G 5/00; G08G 1/00; H04B 1/3822; G01S 19/42; G08G 1/01; B64C 39/02

(52) U.S. Cl. CPC G08G 5/0069; G01S 19/42; G08G 1/0141; G08G 1/20; H04B 1/3822; G08G 5/0008; G08G 5/0013; B64C 39/024

(57) ABSTRACT

A navigation system for an unmanned aerial vehicle (UAV). The navigation system includes a dedicated short range communication (DSRC) module onboard the UAV configured to communicate with DSRC modules of land-based vehicles for tracking travel paths of the land-based vehicles and deriving location of roadways based on the travel paths. A flight control module of the UAV is configured to navigate the UAV to follow roadways identified based on the tracked travel paths of the land-based vehicles.

### FIELD

The present disclosure relates to a navigation system for an unmanned aerial vehicle.

### BACKGROUND

This section provides background information related to the present disclosure, which is not necessarily prior art.

Unmanned aerial vehicles (UAVs), also known as drones, have a variety of different commercial, military, and personal uses. For example, UAVs can be used to visually monitor areas with cameras mounted thereto, monitor various conditions with sensors mounted thereto, deliver goods, deliver munitions, etc. As the use of UAVs increases, flight path planning and traffic control issues will become increasingly important to address. The present teachings advantageously provide for navigation systems and methods for UAVs, which address these issues, as ell as numerous others.

### SUMMARY

This section provides a general summary of the disclosure, and is not a comprehensive disclosure of its full scope or all of its features.

The present teachings provide for navigation systems for unmanned aerial vehicles (UAVs), which facilitate safe and orderly navigation of UAVs relative to one another, and surrounding structures and obstacles. The present teachings also facilitate tracking of UAVs and reduce traffic congestion.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 illustrates a navigation system for unmanned aerial vehicles according to the present teachings.

Corresponding reference numerals indicate corresponding parts throughout the several views of the drawings.

### DETAILED DESCRIPTION

Example embodiments will now be described more fully with reference to the accompanying drawings.

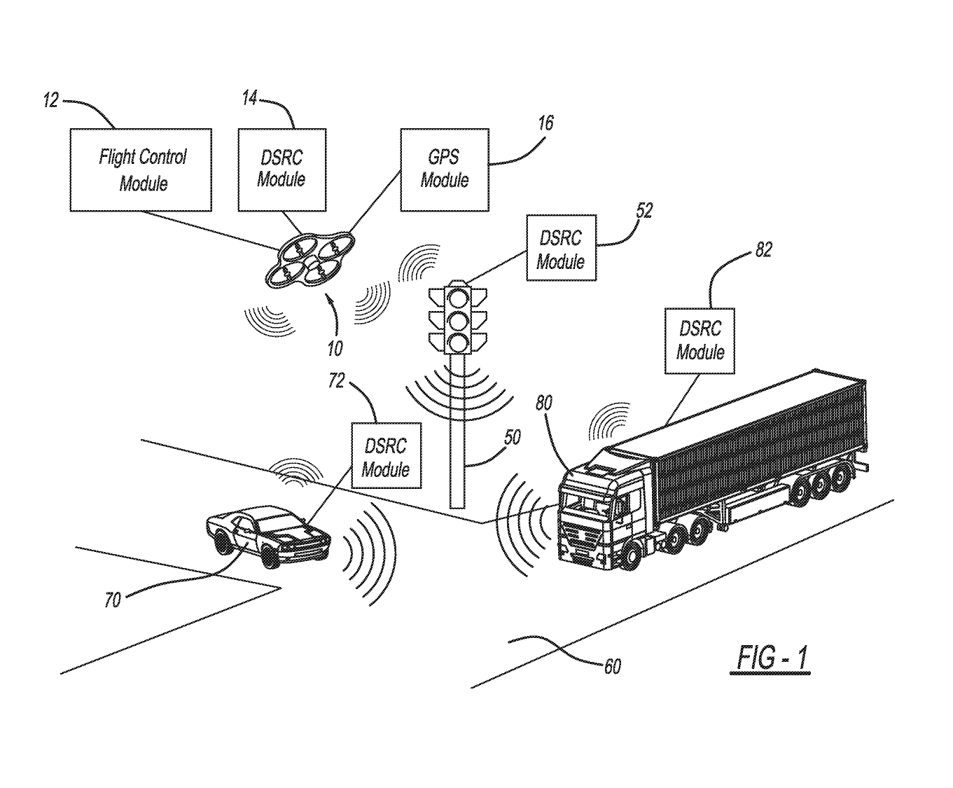

FIG. 1 illustrates a navigation system for unmanned aerial vehicles (UAVs), or drones, according to the present teachings. An exemplary UAV is illustrated at reference numeral 10. The present teachings apply to any suitable UAV, such as any type of civilian, commercial, industrial, military, or government operated UAV, for example.

The UAV 10 generally includes a flight control module 12, a dedicated short range communication (DSRC) module 14, and a global positioning system (GPS) module 16. Throughout this application, the term “module” may be replaced with “circuit.” The term “module” may refer to, be part of, or include processor hardware (shared, dedicated, or group) that executes code, as well as memory hardware (shared, dedicated, or group) that stores code executed by the processor hardware. The code is configured to provide the features of the modules and systems described herein. The term memory hardware is a subset of the term computer-readable medium. The term computer-readable medium, as used herein, does not encompass transitory electrical or electromagnetic signals propagating through a medium (such as on a carrier wave). The term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The flight control module 12 can be any suitable flight control module configured to control flight of the UAV 10. The flight control module 12 is configured to control the direction of the UAV 10 in any suitable manner. For example, the flight control module 12 is configured to control rotors of the UAV 10, which raise, lower, rotate, and move the UAV 10 in any desired direction. When the UAV 10 is configured as a quadcopter or other suitable multirotor vehicle, for example, the flight control module 12 is configured to vary the speed of the rotors to control the direction and rotational orientation of the UAV 10. The flight control module 12 is configured to receive inputs including directional commands for the UAV 10. The inputs and directional commands can come from any suitable source, such as from the DSRC module 14, the GPS module 16, a flight control center, and/or a remote control module.

The DSRC module 14 is configured to communicate with nearby land-based stations and/or vehicles that have DSRC functionality. Thus the DSRC module 14 can include a transmitter and receiver configured to transmit and receive DSRC signals. The DSRC signals can be any suitable radio communication signals, such as any suitable Wi-Fi signals. The Wi-Fi communication can use any suitable radio bands, such as within a range of 5-9 megahertz. The DSRC signals can include any suitable data. For example, DSRC signals transmitted from the DSRC module 14 can include information regarding heading, speed, intended route, type of UAV, etc. As further described herein, the DSRC module 14 can generate inputs to the flight control module 12 for controlling the orientation, position, and/or direction of travel of the UAV 10, such as based on DSRC signals received from other UAVs or vehicles, or from DSRC modules (such as module 52 described herein) mounted to structures or waypoints.

The GPS module 16 of the UAV 10 can include a GPS receiver configured to receive signals from GPS satellites, and can include a map database. Based on the GPS signals received, the GPS module 16 is configured to determine the location of the UAV 10. The GPS module 16 is configured to generate inputs to the flight control module 12, including commands for changing, or maintaining, the position of the UAV 10. For example and as further described herein, the GPS module 16 can be configured to generate directional commands to the flight control module 12 for piloting the UAV along a particular roadway of the map database of the GPS module 16.

An exemplary land-based DSRC station is illustrated in FIG. 1 at reference numeral 50 in the form of a stoplight, which can be positioned at an intersection of a roadway 60, for example. The station 50 includes a DSRC module 52, which is configured to communicate with the DSRC module 14 of the UAV 10 in any suitable manner, such as by Wi-Fi communication. The DSRC module 52 is configured to transmit any suitable signal informing surrounding objects with DSRC capabilities, such as the UAV 10, of the location of the station 50, as well as the type of object that the station 50 is. The land-based station 50 can be a stoplight as illustrated, or any other suitable object, such as a streetlight, bridge, tunnel, building, obstacle, tollbooth, check point, gate, emergency vehicle, construction site, etc. Furthermore, the station 50 can be merely a tower including the DSRC module 52, which may be used as a waypoint for navigating the UAV 10, for example. The DSRC module 14 of the UAV 10 is configured to receive signals from the DSRC module 52, and instruct the flight control module 12 to fly the UAV 10 relative to the station 50, such as from one station 50 to another when multiple stations 50 are used as waypoints, to avoid the station 50 when the station 50 is a building, construction site, emergency vehicle, or other obstacle, or to turn and/or stop at the station 50 when the station 50 is a stoplight at an intersection, as illustrated in FIG. 1.

The DSRC module 14 is further configured to communicate with vehicles on the roadway 60, such as a first vehicle 70 and a second vehicle 80, to receive information regarding, for example, each vehicle's position, heading, speed, intended route, etc. The DSRC module 14 is specifically configured to communicate with DSRC modules 72 and 82 of the first vehicle 70 and the second vehicle 80 respectively. Based on the current and prior locations of vehicles that the DSRC module 14 is able to communicate with, such as one or both of the first and second vehicles 70 and 80, the DSRC module 14 is able to derive the location of the roadway 60, or any other suitable roadway or travel path. The DSRC module 14 can instruct the flight control module 12 to pilot the UAV 10 along the identified roadway or path of travel so as to guide the UAV 10 along an established path. Thus multiple UAVs 10 each including one of the DSRC modules 14 will advantageously travel in an organized manner following existing roadways.

If it is not possible for the DSRC module 14 to identify the location of a roadway, such as due to lack of vehicles with DSRC capabilities present on the roadway 60, the GPS module 16 may be used. Specifically, the GPS module 16 is configured to receive GPS signals from orbiting satellites, and determine location of the UAV 10 based on the GPS signals. The GPS module 16 is further configured to compare location of the UAV 10 to roadways of the map database stored within the GPS module 16, and generate navigational commands to the flight control module 12 for maintaining the flight path of the UAV 10 along a desired roadway of the map database.

The DSRC module 14 can also be configured to relay position information between two or more vehicles, in order to extend the range of DSRC communication therebetween. For example. the DSRC module 14 can receive the position and heading of the first vehicle 70 from the DSRC module 72, and transmit the position and heading of the first vehicle 70 to the DSRC module 82 of the second vehicle 80. Similarly, the DSRC module 14 can receive the position and heading information of the second vehicle 80 from the DSRC module 82, and relay the position and heading of the second vehicle 80 to the DSRC module 72 of the first vehicle 70. Thus the DSRC module 14 is able to extend the range of the DSRC module 72 and 82 so as to inform the first and second vehicles 70 and 80 of each other's respective location and heading.

The DSRC module 14 is also configured to transmit status information of the UAV 10 to surrounding UAVs so that surrounding UAVs are aware of the position and heading of the UAV 10, which can facilitate safe travel of the UAV 10 and surrounding UAVs. The DSRC module 14 is further configured to transmit relevant status information of the UAV 10, such as location, speed, and heading, to the DSRC module 52 of the land-based station 50. The DSRC module 52 of the station 50 is configured to transmit the status information of the UAV 10 to surrounding UAVs, as well as to DSRC modules 52 of other land-based stations 50 for retransmission to other UAVs 10 so that all UAVs 10 can be aware of each other's position, which will facilitate safe and orderly travel of the UAVs 10.

The UAV 10 is also configured to identify the location of vehicles, such as the GPS coordinates of vehicles 70 and/or 80, and transmit the coordinates to the vehicles 70 and/or 80. For example, when the UAV 10 is over or nearby the vehicle 70, such that the UAV 10 and the vehicle 70 are at the same, or generally the same coordinates, the GPS coordinates of the UAV 10 obtained using the GPS module 16 can be transmitted to the vehicle 70 through communication between the DSRC modules 14 and 72 to allow an operator of the vehicle 70 know the location of the vehicle 70. Locations of vehicles can be determined by the UAV 10 in any other suitable manner as well. For example, the UAV 10 can determine the position of the vehicle 70 relative to the UAV 10 in any suitable manner, such as based on transmission distance and direction between the UAV 10 and the vehicle 70, and then the GPS module 16, or any other suitable system of the UAV 10, can be configured to extrapolate the position of the vehicle 70 based on the position of the UAV 10.

The present teachings thus advantageously provide for navigation systems for unmanned aerial vehicles (UAVs), which facilitate safe and orderly navigation of UAVs relative to one another, and surrounding structures and obstacles. The present teachings also provide systems for tracking UAVs and reducing traffic congestion.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to”, or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A navigation system for an unmanned aerial vehicle (UAV), the navigation system comprising:
a dedicated short range communication (DSRC) module onboard the UAV configured to communicate with DSRC modules of land-based vehicles for tracking travel paths of the land-based vehicles and deriving location of roadways based on the travel paths; and
a flight control module of the UAV configured to navigate the UAV to follow roadways identified based on tracked travel paths of the land-based vehicles.

2. The navigation system of claim 1, wherein the DSRC module onboard the UAV is further configured to transmit status information of the UAV, the status information including location, speed, and heading of the UAV.

3. The navigation system of claim 2, wherein the DSRC module onboard the UAV is configured to transmit the status information to at least one of land-based receivers and other UAVs.

4. The navigation system of claim 1, wherein:
the DSRC module onboard the UAV is configured to communicate with DSRC modules of land-based stations to determine location of the UAV relative to the land-based stations; and
the flight control module is configured to navigate the UAV relative to the land-based stations.

5. The navigation system of claim 4, wherein the land-based stations include at least one of the following: a stoplight, streetlight, bridge, tunnel, building, obstacle, tollbooth, checkpoint, gate, emergency vehicle, and construction site.

6. The navigation system of claim 1, wherein the DSRC module onboard the UAV is configured to communicate by WiFi.

7. The navigation system of claim 1, further comprising a global positioning system module onboard the UAV, the flight control module configured to determine location of the UAV based on GPS coordinates and navigate the UAV along roadways of a map database.

8. The navigation system of claim 1, wherein the DSRC module onboard the UAV is configured to relay position information of a first land-based vehicle to a second land-based vehicle.

9. A navigation system for an unmanned aerial vehicle (UAV), the navigation system comprising:
a dedicated short range communication (DSRC) module onboard the UAV configured to communicate with DSRC modules of land-based stations to determine location of the UAV relative to the land-based stations; and
a flight control module configured to navigate the UAV relative to the land-based stations.

10. The navigation system of claim 9, wherein the DSRC module onboard the UAV is further configured to transmit status information of the UAV to at least one of the land-based stations; and
wherein the status information includes at least one of location, speed, and heading of the UAV.

11. The navigation system of claim 9, wherein the DSRC module onboard the UAV is further configured to transmit status information of the UAV to other UAVs;
wherein the status information includes at least one of location, speed, and heading of the UAV.

12. The navigation system of claim 9, wherein the land-based stations include at least one of the following: a stoplight, streetlight, bridge, tunnel, building, obstacle, tollbooth, checkpoint, gate, emergency vehicle, and construction site.

13. The navigation system of claim 9, wherein the DSRC module onboard the UAV is configured to communicate by WiFi.

14. The navigation system of claim 9, further comprising a global positioning system module onboard the UAV, the flight control module configured to determine location of the UAV based on GPS coordinates and navigate the UAV along roadways of a map database.

15. The navigation system of claim 9, wherein the DSRC module onboard the UAV is configured to relay position information of a first land-based vehicle to a second land-based vehicle.

16. A method for navigating an unmanned aerial vehicle (UAV), the method comprising:
tracking travel paths of land-based vehicles using dedicated short range communication (DSRC) between the UAV and the land-based vehicles;
deriving location of roadways based on the tracked travel paths of the land-based vehicles;
communicating with DSRC modules of land-based stations to determine location of the UAV relative to the land-based stations; and
navigating the UAV at least one of: along the roadways identified based on the tracked travel paths of the land-based vehicles; and relative to the land-based stations.

17. The method of claim 16, further comprising transmitting, by DSRC, status information of the UAV to at least one of the land-based stations and nearby UAVs;
wherein the status information includes at least one of location, speed, and heading of the UAV.

18. The method of claim 16, wherein the land-based stations include at least one of the following: a stoplight, a streetlight, bridge, tunnel, building, tollbooth, checkpoint, gate, emergency vehicle, and construction site.

19. The method of claim 16, further comprising transmitting and receiving DSRC communications by WiFi.

20. The method of claim 16, further comprising navigating the UAV over, and along, vehicle roadways using GPS.
